(19) United States
(12) Patent Application Publication
(10) Pub. No.: US 2020/0139850 A1
(43) Pub. Date: May 7, 2020

(54) POWER FOLD SEAT WITH INTUITIVE CONTROLS

(71) Applicant: Ford Global Technologies, LLC, Dearborn, MI (US)

(72) Inventors: Stuart C. Salter, White Lake, MI (US); Aaron Halonen, Brighton, MI (US); Pietro Buttolo, Dearborn Heights, MI (US); Paul Kenneth Dellock, Northville, MI (US); Johnathan Andrew Line, Northville, MI (US); Michael Kolich, Windsor (CA)

(73) Assignee: Ford Global Technologies, LLC, Dearborn, MI (US)

(21) Appl. No.: 16/178,968

(22) Filed: Nov. 2, 2018

(51) Int. Cl. B60N 2/02; B60N 2/20; B60R 21/015; G06F 3/044

(52) U.S. Cl. CPC B60N 2/0228; B60N 2/20; G06F 3/0488; B60R 21/01516; G06F 3/044; B60N 2/0248

(57) ABSTRACT

A vehicle seating assembly is provided herein. The seating assembly includes a seat-base. A seatback is pivotally coupled to the seat-base and includes a trim cover. The trim cover includes a front-portion, an upper-portion, and a rear-portion. A motorized system is coupled to the seatback and operable to pivot the seatback relative to the seat-base. A switch extends along the upper-portion and the rear-portion of the trim cover and is configured to activate the motorized system.

### FIELD OF THE INVENTION

The present invention generally relates to a vehicle seating assembly and, more particularly, to a switch positioned on a seatback of the vehicle seating assembly configured to control power folding of the seatback.

### BACKGROUND OF THE INVENTION

Vehicle seating assemblies often include a seatback, a seat-base, and a motorized system configured to pivot the seatback relative to the seat-base for the convenience of a vehicle occupant seated in the seating assembly. These vehicle seating assemblies typically include an actuation switch that allows a user to operate the motorized system; however, the actuation switch is often located in an area that is inconvenient for the vehicle occupant to access when the vehicle occupant is not seated in the seating assembly.

### SUMMARY OF THE INVENTION

According to one aspect of the present invention, a vehicle seating assembly includes a seatback pivotally coupled to a seat-base and having a trim cover. The trim cover includes a front-portion, an upper-portion, and a rear-portion. A motorized system is coupled to the seatback and operable to pivot the seatback relative to the seat-base. A switch extends along the upper-portion and the rear-portion of the trim cover and is configured to activate the motorized system.

Embodiments of the first aspect of the invention can include any one or a combination of the following features:
the upper-portion of the trim cover is between the front-portion and the rear-portion;
a headrest coupled to the upper-portion of the trim cover;
the switch is generally flush with the upper-portion of the trim cover adjacent to the switch and the rear-portion of the trim cover adjacent to the switch;
the switch is a proximity switch configured to be engaged via touch events by a user; and
the proximity switch is a capacitive switch configured to detect obstacles in a pivoting path of the seatback.

According to another aspect of the present invention, a vehicle seating assembly includes a seatback pivotally coupled to the seat-base. The seatback includes a trim cover that comprises an upper-portion and a rear-portion. A motorized system is coupled to the seatback and operable to pivot the seatback relative to the seat-base upon activation. The upper-portion and the rear-portion of the trim cover are coupled to a switch configured to activate the motorized system in response to a user engaging the switch.

Embodiments of the second aspect of the invention can include any one or a combination of the following features:
the switch comprises a proximity switch;
the proximity switch is configured to be engaged by the user via touch events;
the proximity switch is configured to detect obstacles in a pivoting path of the seatback;
the switch continuously extends along a portion of both the upper-portion and the rear-portion of the trim cover; and
a contour of the switch is generally parallel to a contour of the seatback adjacent to the switch.

According to yet another aspect of the present disclosure, a vehicle seating assembly includes a seatback pivotally coupled to a seat-base. The seatback includes a trim cover and is operable to be pivoted by a motorized system coupled to the seatback. A switch extends along an upper-portion and a rear-portion of the trim cover. The motorized system is configured to pivot the seatback in response to a signal from the switch and at least one of a seatback position signal and an occupant presence signal.

Embodiments of the third aspect of the invention can include any one or a combination of the following features:
a controller configured to receive a signal from the switch and receive at least one of the seatback position signal and the occupant presence signal, and control the motorized system based on the received signals;
the switch is configured to detect obstacles in a pivoting path of the seatback;
the controller is configured to stop the motorized system from pivoting the seatback such that the seatback would contact an obstacle in the path of the seatback upon receiving a signal from the switch that the obstacle is in the path of the seatback;
the signal received by the controller from the switch does not influence what direction the controller will prompt the motorized system to pivot the seatback;
the switch comprises a proximity switch;
the proximity switch is a capacitive switch configured to be engaged by the user via touch events; and
the switch continuously extends along a portion of both the upper-portion and the rear-portion of the trim cover.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a perspective view of a seating assembly illustrated in a stowed position within a vehicle interior, with a switch positioned on a seatback of the seating assembly, according to one embodiment;

FIG. 2A is a perspective view of the seating assembly, illustrating a front-side of the seatback, according to one embodiment;

FIG. 2B is a perspective view of the seating assembly, illustrating a rear-side of the seatback, according to one embodiment;

FIG. 3 is a top perspective view of the vehicle seating assembly in an upright position, illustrating the switch positioned on an upper-surface of the seatback and a rear-surface of the seatback, according to one embodiment;

FIG. 4 is a side perspective view of the seating assembly illustrated in the stowed position, with the switch positioned on an upper-surface of the seatback and a rear-surface of the seatback, according to one embodiment;

FIG. 5 is a cross-sectional view taken through line V-V of FIG. 3, illustrating the switch coupled to the seatback, according to one embodiment; and

FIG. 6 is a block diagram of various components of the vehicle, illustrating inputs received by a controller and the connection between the controller and a motorized system, according to one embodiment.

### DETAILED DESCRIPTION OF THE PREFERRED EMBODIMENTS

Additional features and advantages of the invention will be set forth in the detailed description which follows and will be apparent to those skilled in the art from the description, or recognized by practicing the invention as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature, or may be removable or releasable in nature, unless otherwise stated.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

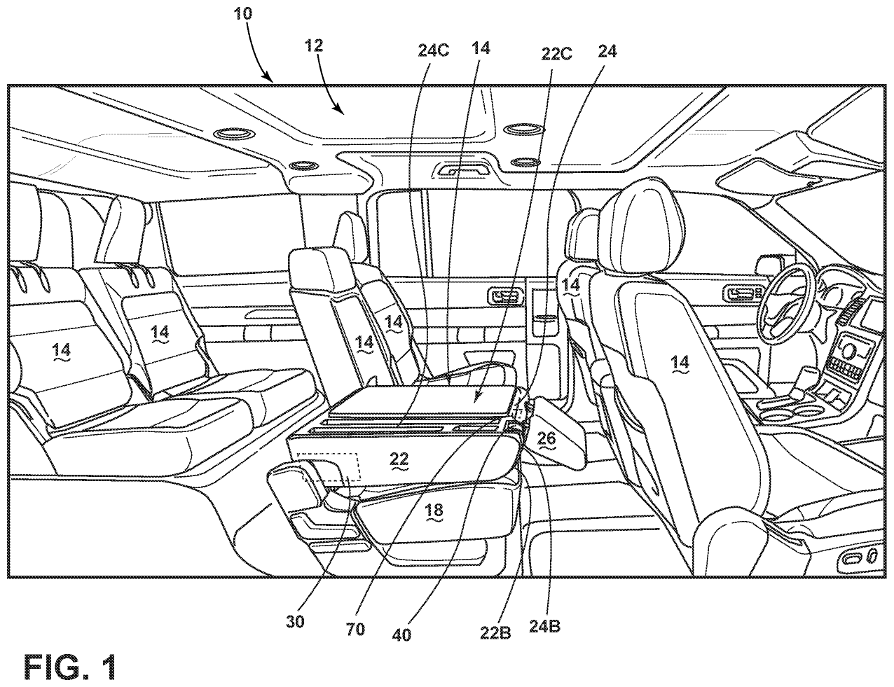

In reference to FIGS. 1-4, a vehicle 10, such as a wheeled motor vehicle, is disclosed. The vehicle 10 includes a seating assembly 14. The seating assembly 14 includes a seat-base 18. A seatback 22 is pivotally coupled to the seat-base 18 and includes a trim cover 24. The trim cover 24 includes a front-portion 24A, an upper-portion 24B, and a rear-portion 24C. A motorized system 30 is coupled to the seatback 22 and operable to pivot the seatback 22 relative to the seat-base 18. A switch 40 extends along the upper-portion 24B and the rear-portion 24C of the trim cover 24 and is configured to activate the motorized system 30.

Referring now to FIG. 1, the vehicle 10 is depicted. It is contemplated that the vehicle 10 may be at least one of a variety of vehicle types (e.g., van, truck, sedan, SUV, etc.). The vehicle 10 includes a vehicle interior 12. The vehicle interior 12 includes the seating assembly 14. It is further contemplated that the seating assembly 14 may be at least one of a host of different types of vehicle seats (e.g., bucket seat, bench seat, captain's chair, etc.). In various embodiments, the seating assembly 14 may move in vehicle forward and rearward directions. For example, the seating assembly 14 may move vehicle forward and rearward in a conventional manner by sliding along rail slides. In some embodiments, the seating assembly 14 may move in various directions within the vehicle interior 12 and/or rotate or swivel relative to the vehicle interior 12, such that the seating assembly 14 may face various vehicular directions. The vehicle 10 may include a plurality of seating assemblies 14. In some embodiments, the seating assemblies 14 may be arranged in rows. For example, as depicted in FIG. 1, the vehicle interior 12 may include a first row of seating assemblies 14, a second row of seating assemblies 14 positioned vehicle rearward of the first row, and a third row of seating assemblies 14 positioned vehicle rearward of the second row. It is contemplated that, in various embodiments, there may be any feasible number of rows of seating assemblies 14 within the vehicle interior 12 and that the vehicle 10 may be any vehicle 10 configured with a seating assembly 14.

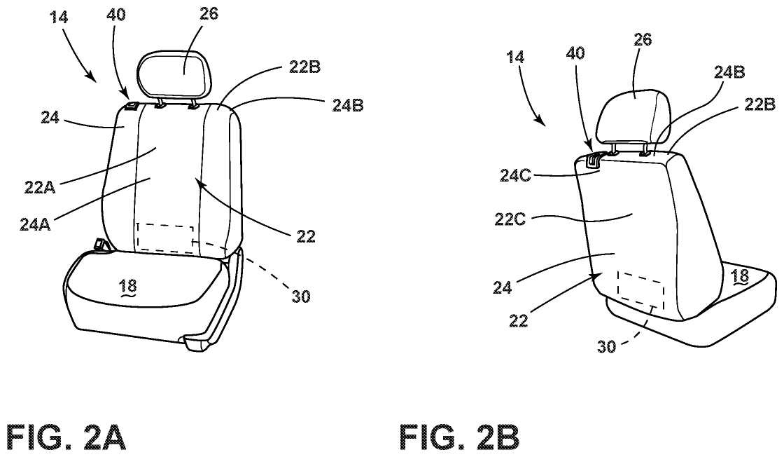

Referring now to FIGS. 1-2B, the seating assembly 14 may include the seat-base 18 and the seatback 22. As shown in FIGS. 2A and 2B, the seatback 22 includes a front-side 22A, an upper-side 22B, and a rear-side 22C. In various embodiments, a vehicle occupant seated in the seating assembly 14 may lean back against the front-side 22A of the seatback 22. The rear-side 22C may face generally the opposite direction of the front-side 22A. The upper-side 22B may be positioned between the front-side 22A and the rear-side 22C of the seatback 22. In some embodiments, a headrest 26 may be coupled to the seatback 22. In some embodiments, the headrest 26 and/or a portion thereof may be coupled to and/or extend outward from the upper-side 22B of the seatback 22. It is contemplated that the headrest 26 may be coupled to the seatback 22 and/or integral with the seatback 22.

In various embodiments, the seatback 22 may include the trim cover 24. The trim cover 24 may include the front-portion 24A, the upper-portion 24B, and the rear-portion 24C. The front-portion 24A of the trim cover 24 corresponds to the front-side 22A of the seatback 22. In other words, the front-portion 24A of the trim cover 24 is the portion of the trim cover 24 that covers the front-side 22A of the seatback 22. Likewise, the upper-portion 24B of the trim cover 24 corresponds to the upper-side 22B of the seatback 22, and the rear-portion 24C of the trim cover 24 corresponds to the rear-side 22C of the seatback 22. As such, a vehicle occupant seated in the seating assembly 14 may lean back against at least a part of the front-portion 24A of the trim cover 24. Further, in some embodiments, the rear-portion 24C may face generally the opposite direction of the front-portion 24A. In various embodiments, the upper-portion 24B may be positioned between the front-portion 24A and the rear-portion 24C of the trim cover 24. In some embodiments, the headrest 26 and/or a portion thereof may be coupled to and/or extend outward from the upper-portion 24B of the trim cover 24. The trim cover 24 may be formed of at least one of a host of materials that includes, but is not limited to, leather, vinyl, plastic, cloth, metal, natural materials, rubber, and/or a combination thereof.

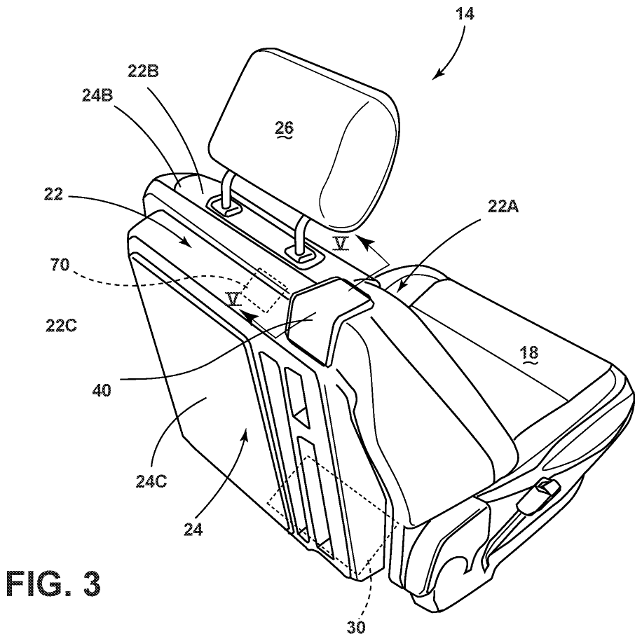

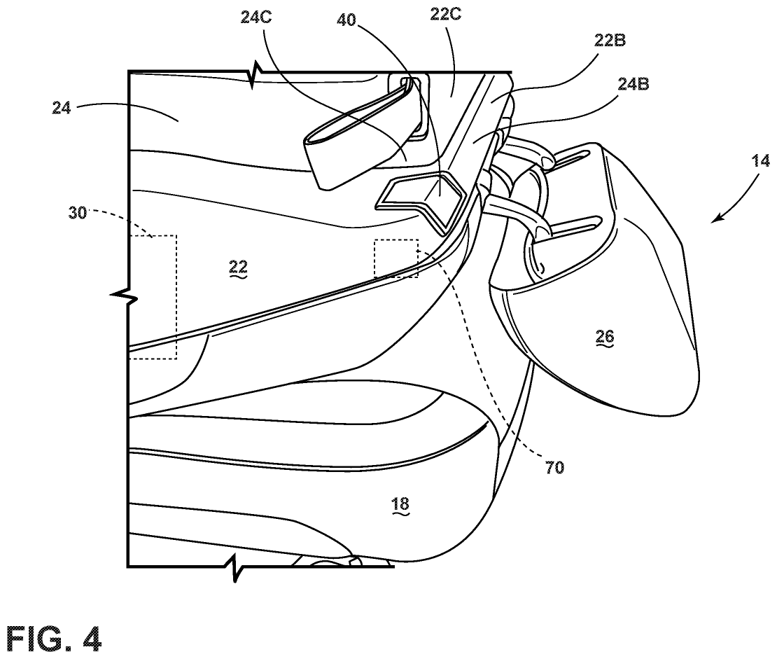

Referring now to FIGS. 3 and 4, in various embodiments, the seatback 22 may be pivotally coupled with the seat-base 18. In some embodiments, the seatback 22 may be operable to pivot relative to the seat-base 18 between various pivotal positions. In some examples, the seatback 22 may be configured to pivot between an upright position, as shown in FIG. 3, and a stowed position, as shown in FIG. 4. It is contemplated that in some examples, the seatback 22 may be configured to pivot to a position between and/or beyond the upright position and the stowed position.

In reference to FIGS. 1-4 and 6, the seating assembly 14 may include the motorized system 30. The motorized system 30 may include a motor 32. The motor 32 may be a servo motor or a stepper motor, though any suitable type of motor is contemplated. It is further contemplated that, in some embodiments, the motorized system 30 may include multiple motors 32. In various embodiments, the motorized system 30 may include a variety of other components configured to interact with the motor 32 and/or be moved by the motor 32 (e.g., gears, pulleys, cables, etc.). In various embodiments, the motor 32 may be electrically coupled to a vehicle electrical system, which may be positioned in any suitable location within or remote from the seating assembly 14. In some embodiments, the motorized system 30 may be operable between an activated state, wherein the motor 32 is selectively energized, and a deactivated state. In some embodiments, the motorized system 30 may move via operation of the motor 32 while in the activated state. The motorized system 30 may be activated in response to engagement of the switch 40, which is electrically coupled to the motorized system 30 and/or in response to an output by a controller 70 that is electrically coupled to the motorized system 30.

Referring now to FIGS. 1-4, the motorized system 30 may be coupled to the seatback 22 of the seating assembly 14. In various embodiments, the motorized system 30 may be configured to pivot the seatback 22. For example, in some embodiments, upon activation, (i.e. when the motorized system 30 enters the activated state) the motorized system 30 is configured to pivot the seatback 22 relative to the seat-base 18. It is contemplated that the motorized system 30 may be operable to pivot the seatback in various directions and, further, that the motorized system 30 may be operable to pivot the seatback 22 between various positions. For example, in some embodiments, the motorized system 30 may be operable to pivot the seatback 22 to, between, and/or beyond the upright and stowed positions. It is to be understood that, in some embodiments, the motor 32 of the motorized system 30 need not be disposed within and/or directly coupled to the seatback 22. For example, in some embodiments, the motor 32 may be located in the seat-base 18 and may cause the seatback 22 to pivot via the motor's 32 influence of other components of the motorized system 30 that are directly coupled to the seatback 22.

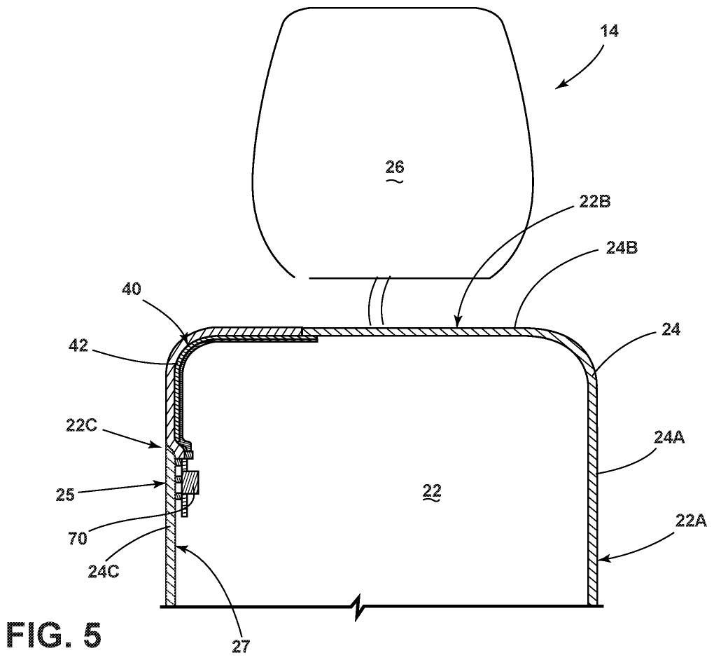

In reference to FIGS. 3-5, the seating assembly 14 may include the switch 40. In various embodiments, the switch 40 may be at least one of a variety of switch types that includes, but is not limited to, a toggle switch, a rocker switch, a micro switch, an electronic push button switch, and/or a combination thereof. In some embodiments, the switch 40 may be one or more proximity switches 42, as shown in FIG. 5. The one or more proximity switches 42 are shown and described herein as one or more capacitive switches. Each proximity switch 42 includes at least one proximity sensor that provides a sense activation field to sense contact or close proximity (e.g., within one millimeter) of a user in relation to the one or more proximity sensors, such as a swiping motion or pressing by a user's finger. Thus, the sense activation field of each proximity switch 22 is a capacitive field in the exemplary embodiment and the user's finger has electrical conductivity and dielectric properties that cause a change or disturbance in the sense activation field as should be evident to those skilled in the art. However, it should also be appreciated by those skilled in the art that additional or alternative types of proximity switches 42 and/or proximity sensors can be used, such as, but not limited to, inductive sensors, optical sensors, temperatures sensors, resistive sensors, the like, or a combination thereof. Exemplary proximity sensors are described in the Apr. 9, 2009, ATMEL® Touch Sensors Design Guide, 10620 D-AT42-04/09, the entire reference hereby being incorporated herein by reference.

In various embodiments, the switch 40 may be operable between an engaged state and a disengaged state. In some embodiments, a user may be able to engage and/or disengage the switch 40. In other words, the user may be able to operate the switch 40 such that it enters the engaged state and/or the disengaged state.

In embodiments where the switch 40 is the proximity switch 42, the user may engage the switch 40 via a touch event. In some embodiments, in which the proximity switch 42 is a capacitive switch, a touch event may occur when the user touches the proximity switch 42 and causes a change in capacitance. In some embodiments, whether a touch on the proximity switch 42 registers as a touch event depends on the nature, amount, and/or duration of the change in capacitance caused by the touch. Accordingly, whether a touch registers as a touch event may depend on a variety of factors including, but not limited to, the duration of the touch, the surface area of the proximity switch 42 contacted by the touch, the pressure applied to the proximity switch 42 by the touch, the location on the proximity switch 42 that the touch occurred, and/or a combination thereof. For example, in some embodiments, the change in capacitance that results from a relatively light touch by the user may not register as a touch event, while the change in capacitance that results from a user pushing relatively firmly on the proximity switch 42 may register as a touch event. Further, in some embodiments, briefly pushing on the proximity switch 42 may not register as a touch event, while pushing the proximity switch 42 for a certain duration may register as a touch event. Whether a given user touch is a touch event that engages the proximity switch 42 may be determined by logic 76 within the controller 70 and/or by one or more other controllers. It is contemplated that, in some embodiments, whether a given user touch is a touch event may be determined without the controller 70 and/or one or more other controllers. It is further contemplated that, in some embodiments, close proximity to the proximity switch 42 by a user without a touch occurring may result in a change in capacity that registers as a touch event.

Referring now to FIGS. 3-6, the switch 40 may be electrically coupled to the motorized system 30 and/or the controller 70 and configured to activate the motorized system 30 upon engagement of the switch 40 by the user. As such, in various examples, engagement of the switch 40 may prompt the motorized system 30 to pivot the seatback 22. For example, in some embodiments, in which the switch 40 is the proximity switch 42, a user may engage the proximity switch 42 via a touch event, which activates the motorized system 30 causing the motorized system 30 to pivot the seatback 22 relative to the seat-base 18.

As shown in FIGS. 3-5, the switch 40 may be coupled to the seatback 22. In various embodiments, the switch 40 may be coupled to the trim cover 24. In some embodiments, the switch 40 may be coupled to the upper-portion 24B and the rear-portion 24C of the trim cover 24. For example, as shown in FIGS. 3-5, in some embodiments, the switch 40 may extend along the upper-portion 24B and the rear-portion 24C of the trim cover 24.

In some embodiments, the switch 40 may be generally flush with the upper-portion 24B and the rear-portion 24C of the trim cover 24. In some examples, the switch 40 may be substantially flush with the upper-portion 24B and the rear-portion 24C of the trim cover 24. In some embodiments, the switch 40 may be generally and/or substantially flush with the upper-portion 24B of the trim cover 24 adjacent to the switch 40 and/or the rear-portion 24C of the trim cover 24 adjacent to the switch 40. In some embodiments, a contour of the switch 40 may be generally and/or substantially parallel to a contour of the seatback 22 adjacent to the switch 40. In some embodiments, the switch 40 may continuously extend along a portion of both the upper-portion 24B and the rear-portion 24C of the trim cover 24, as depicted in FIGS. 3 and 4. It is contemplated that the switch 40 may be coupled to an exterior surface 25 and/or an interior surface 27 of the trim cover 24. Further, the switch 40 may be disposed between the exterior surface 25 and the interior surface 27 of the trim cover 24. For example, as shown in FIG. 5, the switch FIG. 40, which is depicted as the proximity switch 42, is coupled to the interior surface 27 of the trim cover 24 and extends through the trim cover 24 such that the external periphery of the proximity switch 42 is substantially flush with the external surface 25 of the trim cover 24.

In some embodiments, in which the switch 40 includes the proximity switch 42, the portion of the proximity switch 42 that a touch event occurs on may determine the action resulting from the touch event. For example, in some embodiments, registering a touch event on the portion of the proximity switch 42 that extends along the rear-portion 24C of the trim cover 24 may prompt the motorized system 30 to pivot the seatback 22 toward the stowed position, while registering a touch event on the portion of the proximity switch 42 that extends along the upper-portion 24B of the trim cover 24 may prompt the motorized system 30 to pivot the seatback 22 toward the upright position. In other embodiments, a gesture such as sliding the finger in a particular direction may command movement to a position. The result produced by a touch event on a certain portion of the proximity switch 42 and/or by a gesture along the proximity switch 42 may be determined by logic 76 within the controller 70 and/or by one or more other controllers. It is contemplated that, in some embodiments, the result may be determined without the controller 70 and/or one or more other controllers.

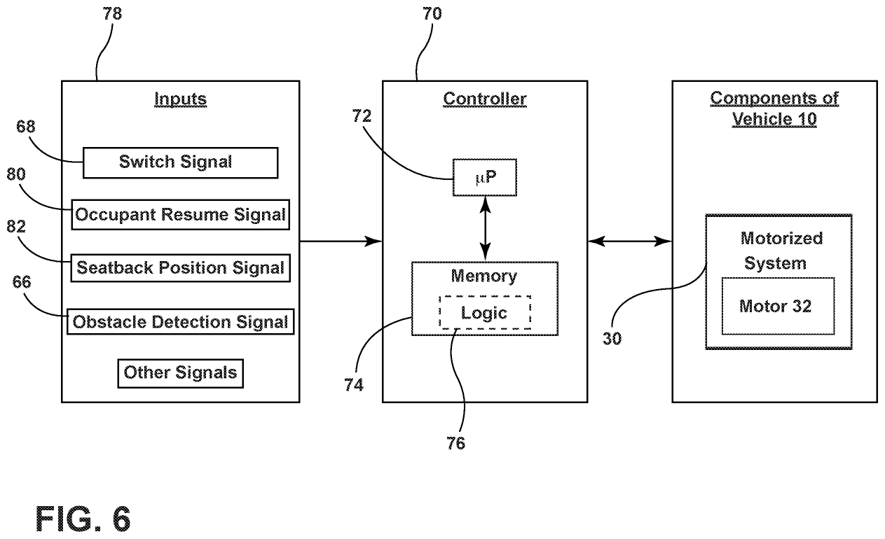

Referring now to FIG. 6, as referenced above, the seating assembly 14 may include the controller 70, which may be configured to receive various inputs 78 and control various outputs. The controller 70 may include a microprocessor 72 and memory 74 as illustrated, according to various embodiments. It should be appreciated that the controller 70 may include control circuitry such as analog and/or digital control circuitry. Stored within the memory 74 and executed by the microprocessor 72 is logic 76 for processing the various inputs 78 and controlling various outputs described herein.

As shown in FIG. 6, the inputs 78 to the controller 70 may include a switch signal 68, which may be made available from the the switch 40 and/or another controller, and may indicate whether the switch 40 has been and/or is being engaged. The controller 70 may receive the switch signal 68, indicating engagement of the switch 40, in response to the switch 40 being engaged by a user. For example, in some embodiments, in which the switch 40 includes the proximity switch 42, the controller 70 may receive the switch signal 68 from the switch 40 and/or another controller, indicating that the switch 40 has been engaged, in response to a touch event by a user on the proximity switch 42.

As further depicted in FIG. 6, the inputs 78 to the controller 70 may include an occupant presence signal 80, which may be made available from a data collecting feature (e.g., weight sensor, proximity sensor, camera, etc.) and/or another controller, and may indicate the presence or absence of an occupant in the seating assembly 14. It is contemplated that the presence or absence of an occupant in the seating assembly 14 may be determined through a variety of methods and/or by a variety of features.

As further shown in FIG. 6, in various embodiments, the controller 70 may receive a seatback position signal 82 as the input 78. The seatback position signal 82 may be made available from a data collecting feature (e.g., Hall Effect sensor, camera, proximity sensor, etc.) and/or another controller, and may indicate the pivotal position of the seatback 22. For example, the seatback position signal 82 may indicate that the seatback 22 is in the stowed position, the upright position, or a position between or beyond the stowed and upright positions. Referring further to FIG. 6, in some embodiments, the controller may receive an obstacle detection signal 66 as an input 78, which may be made available from a data collecting feature (e.g., camera, proximity sensor, weight sensor, mechanical resistance sensor, etc.) and/or another controller, and may indicate that an obstacle has been sensed in the pivoting path of the seatback 22. In some embodiments, in which the switch 40 includes the proximity switch 42, the switch 40 may be operable to detect whether an obstacle is in the pivoting path of the seatback 22 and relay the obstacle detection signal 66. For example, in some embodiments, the proximity switch 42 may be the capacitive switch and may be configured to operate as a capacitive obstacle sensor as the seatback 22 moves toward the stowed position. In some embodiments, the controller 70 may be configured to stop the motorized system 30 from pivoting the seatback 22 in such a way that the seatback 22 would contact an obstacle in the path of the seatback 22 upon receiving a signal from the switch 40 that the obstacle is in the path of the seatback 22. In some embodiments, the inputs 78 to the controller 70 may include various other signals, such as signals from other controllers within the vehicle 10, signals sent to the controller 70 by activation of other switches by an occupant, and/or signals indicating various vehicle conditions (e.g., vehicle speed, transmission gear position, etc.).

In further reference to FIG. 6, the controller 70, upon processing the inputs 78, may control various outputs. In various embodiments, the controller 70 may be configured to control the motorized system 30, and thereby the position of the seatback 22, upon processing the inputs 78. In some embodiments, the controller 70 may control whether the motorized system 30 pivots the seatback 22, the direction the motorized system 30 pivots the seatback 22, the speed the motorized system 30 pivots the seatback 22, the distance the motorized system 30 pivots the seatback 22, and/or a combination thereof, upon processing the switch signal 68, the occupant presence signal 80, the seatback position signal 82, the obstacle detection signal 66, one or more other signals, and/or a combination thereof. For example, in some embodiments, the controller 70 may prompt the motorized system 30 to pivot the seatback 22 toward the upright position upon receiving a switch signal 68 indicating engagement of the switch 40 and a seatback position signal 82 indicating that the seatback 22 is in the stowed position. In some embodiments, the controller 70 may prevent the motorized system 30 from pivoting the seatback 22 upon receiving an occupant presence signal 80 indicating that the seating assembly 14 is occupied. In some embodiments, the switch signal 68 received by the controller 70 from the switch 40 does not influence what direction the controller 70 will prompt the motorized system 30 to pivot the seatback 22. In other words, in some embodiments, the direction the controller 70 prompts the motorized system 30 to pivot the seatback 22 is wholly dependent on inputs 78 other than the switch signal 68.

In operation, a vehicle occupant desiring to move the seatback 22 of the seating assembly 14 may engage the switch 40. The engagement of the switch 40 activates the motor 32 of the motorized system 30. This activation of the motor 32 causes the motorized system 30 to pivot the seatback 22 relative to the seat-base 18. In some embodiments, in which the switch 40 includes the proximity switch 42 positioned on the upper-portion 24B and the rear-portion 24C of the trim cover 24 of the seatback 22, a vehicle occupant positioned vehicle forward of the seating assembly 14 and desiring to move the seatback 22 from the stowed position to the upright position may intuitively contact the portion of the proximity switch 42 extending along the upper-portion 24B of the trim cover 24 to activate the motorized system 30 and cause the seatback 22 to pivot to the upright position. Further, a vehicle occupant positioned vehicle rearward of the seating assembly 14 and desiring to move the seatback 22 from the upright position to the stowed position may intuitively contact the portion of the proximity switch 42 extending along the rear-portion 24C of the trim cover 24 to activate the motorized system 30 and cause the seatback 22 to pivot to the stowed position.

Use of the present disclosure may provide a variety of advantages. First, the switch 40 extending along both the upper-portion 24B and the rear-portion 24C of the trim cover 24 may make operating the switch 40 more convenient for vehicle occupants not seated in the seating assembly 14. Second, the switch 40 extending along both the upper-portion 24B and the rear-portion 24C of the trim cover 24 may make operating the switch 40 more intuitive to the operator regardless of the pivotal position of the seatback 22. Third, having a switch 40 that is generally parallel to the contours of the seatback 22 and/or is generally flush with the adjacent trim cover 24 may cause the seatback 22 to appear more streamlined and aesthetically pleasing to an onlooker.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A vehicle seating assembly, comprising:
a seatback pivotally coupled to a seat-base and having a trim cover, wherein the trim cover includes a front-portion, an upper-portion, and a rear-portion;
a motorized system coupled to the seatback and operable to pivot the seatback relative to the seat-base; and
a switch extending along the upper-portion and the rear-portion of the trim cover and configured to activate the motorized system.

2. The vehicle seating assembly of claim 1, wherein the upper-portion of the trim cover is between the front-portion and the rear-portion.

3. The vehicle seating assembly of claim 2, further comprising:
a headrest coupled to the upper-portion of the trim cover.

4. The vehicle seating assembly of claim 1, wherein the switch is generally flush with the upper-portion of the trim cover adjacent to the switch and the rear-portion of the trim cover adjacent to the switch.

5. The vehicle seating assembly of claim 1, wherein the switch is a proximity switch configured to be engaged via touch events by a user.

6. The vehicle seating assembly of claim 5, wherein the proximity switch is a capacitive switch configured to detect obstacles in a pivoting path of the seatback.

7. A vehicle seating assembly, comprising:
a seatback pivotally coupled to a seat-base and having a trim cover that comprises an upper-portion and a rear-portion; and
a motorized system coupled to the seatback and operable to pivot the seatback relative to the seat-base upon activation, wherein the upper-portion and the rear-portion of the trim cover are coupled to a switch configured to activate the motorized system in response to a user engaging the switch.

8. The vehicle seating assembly of claim 7, wherein the switch comprises a proximity switch.

9. The vehicle seating assembly of claim 8, wherein the proximity switch is configured to be engaged by the user via touch events.

10. The vehicle seating assembly of claim 9, wherein the proximity switch is configured to detect obstacles in a pivoting path of the seatback.

11. The vehicle seating assembly of claim 7, wherein the switch continuously extends along a portion of both the upper-portion and the rear-portion of the trim cover.

12. The vehicle seating assembly of claim 7, wherein a contour of the switch is generally parallel to a contour of the seatback adjacent to the switch.

13. A vehicle seating assembly, comprising:
a seatback pivotally coupled to a seat-base, wherein the seatback comprises a trim cover and is operable to be pivoted by a motorized system coupled to the seatback; and
a switch extending along an upper-portion and a rear-portion of the trim cover, wherein the motorized system is configured to pivot the seatback in response to a signal from the switch and at least one of a seatback position signal and an occupant presence signal.

14. The vehicle seating assembly of claim 13, further comprising:
a controller configured to receive a signal from the switch and receive at least one of the seatback position signal and the occupant presence signal, and control the motorized system based on the received signals.

15. The vehicle seating assembly of claim 14, wherein the switch is configured to detect obstacles in a pivoting path of the seatback.

16. The vehicle seating assembly of claim 15, wherein the controller is configured to stop the motorized system from pivoting the seatback such that the seatback would contact an obstacle in the path of the seatback upon receiving a signal from the switch that the obstacle is in the path of the seatback.

17. The vehicle seating assembly of claim 14, wherein the signal received by the controller from the switch does not influence what direction the controller will prompt the motorized system to pivot the seatback.

18. The vehicle seating assembly of claim 13, wherein the switch comprises a proximity switch.

19. The vehicle seating assembly of claim 18, wherein the proximity switch is a capacitive switch configured to be engaged by the user via touch events.

20. The vehicle seating assembly of claim 13, wherein the switch continuously extends along a portion of both the upper-portion and the rear-portion of the trim cover.
